(19) United States
(12) Patent Application Publication
(10) Pub. No.: US 2006/0039537 A1
(43) Pub. Date: Feb. 23, 2006

(54) C-arm device with adjustable detector offset for cone beam imaging involving partial circle scan trajectories

(76) Inventor: Norbert Karl Strobel, Palo Alto, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/237,437

(22) Filed: Sep. 28, 2005

Related U.S. Application Data
(63) Continuation-in-part of application No. 11/140,225, filed on May 27, 2005.
(60) Provisional application No. 60/575,193, filed on May 28, 2004.

(51) Int. Cl. H05G 1/02

(52) U.S. Cl. 378/197

(57) ABSTRACT

A C-arm x-ray imaging system enhances reconstructed volumes internal to a patient. Truncation artifacts in reconstructed volume data sets may be reduced by creating an effective x-ray detector of greater size. The x-ray detector may include a movable stage and a detector mount. The movable stage may be movable within the x-ray detector mount. A first partial circular scan may be performed with the movable stage at a first position. The movable stage may be repositioned to a second position before a second partial circular scan is performed. Performing two partial circular scans with the movable stage located at different positions may increase the effective size of the x-ray detector. The associated views acquired with the detector in opposite offset positions are combined and used for 3D reconstruction. A method of calibration may include generating first and second projection matrices associated with first and second transform parameters, respectively.

### PRIORITY CLAIM TO RELATED APPLICATION

This application is a continuation-in-part of and claims priority to prior application Ser. No. 11/140,225, filed May 27, 2005, the disclosure of which is incorporated by reference in its entirety herein.

### BACKGROUND

The present embodiments relate generally to C-arm x-ray systems used for medical imaging. In particular, the present embodiments relate to the correction of truncated projections that may occur with C-arm x-ray imaging systems.

C-arm imaging systems are currently used in medical applications to create both two dimensional x-ray projections and three dimensional tomographically reconstructed images (volume data sets). Conventional C-arm imaging systems, like other cone-beam imaging devices, may be equipped with x-ray detectors that are too small to fully capture a projection of a given object. Typical x-ray detectors may create truncated projections when recording views of objects that extend beyond the boundaries of the detector. Since the Detector Field of View (DFOV) determines the associated Scan Field of View (SFOV) for 3D reconstruction, a small x-ray detector may limit the overall size of an object that may be properly examined and accurately reconstructed.

Conventional mathematical extrapolation methods may reduce the impact of truncated projections. However, for best results, typical extrapolation methods may still require the capture of the full object in at least some of the views to establish data consistency conditions, e.g., the overall object mass (zeroth moment) and the center of mass (based upon first moments). Therefore, the x-ray detector may be required to cover the full projection of the object. Given the size of the detector and the object to be imaged, it is common for this not to be feasible unless the patient is moved and multiple projections are taken such that they can be stitched together for a full view. Unfortunately, this approach is not very practical, because it can only applied for selected views, e.g., AP and lateral views.

In addition to mathematical extrapolation methods, a variety of hardware modifications to x-ray systems have been proposed to address the problem of truncated projections. U.S. Pat. No. 5,032,990 to Eberhard et al. discloses a two position data acquisition scheme in which an object is translated and rotated relative to a stationary source-detector configuration. U.S. Pat. No. 5,740,224 to Muller et al. discloses linear and circular synthetic scanner arrays. The scanner remains stationary and the object to be scanned is mounted on a turntable that may be displaced and rotated. However, both of these proposed solutions are not easily applicable to C-arm x-ray imaging systems.

Cho et al., “Cone-Beam CT from width-truncated Projections,” Computerized Medical Imaging and Graphics, vol. 20, no. 1, pp. 49-57, 1996, discloses performing a full circle scan with a laterally offset detector. While this method may increase the effective detector width, Cho et al. is not applicable to C-arm imaging systems, as C-arms may be limited to only partial circular scans.

### BRIEF SUMMARY

By way of introduction, the embodiments described below include methods, processes, apparatuses, instructions, or systems for reconstructing enhanced volumes using C-arm x-ray imaging systems. Two partial circular scans may be performed by a C-arm imaging system. The C-arm may comprise an x-ray detector having a movable stage. The movable stage of the x-ray detector may be repositioned between the partial circular scans to reduce or eliminate truncated projections by combining associated x-ray projections taken at the same angular positions but with offset detector. A method of calibration may be performed using the C-arm imaging system to further facilitate enhanced image reconstruction.

In a first aspect, an x-ray imaging system includes an x-ray source mounted to one end of a C-arm and an x-ray detector mounted to an opposite end of the C-arm. The x-ray detector includes a detector mount and a movable stage that is operable to move within the detector mount.

In a second aspect, an x-ray detector for an imaging system includes a detector mount capable of being coupled with a C-arm. The x-ray detector also has a movable stage coupled to the detector mount that is operable to translate along the detector mount. In a third aspect, a method of imaging employs a C-arm x-ray imaging system. The method includes positioning a movable stage of an x-ray detector at a first position, performing a first partial circular scan to acquire a first set of projection data, repositioning the movable stage of the x-ray detector to a second position offset from the first position, and performing a second partial circular scan to acquire a second set of projection data.

In a fourth aspect, a method calibrates a C-arm x-ray imaging system. The method includes centering a movable stage of an x-ray detector, performing a standard C-arm calibration procedure, and generating a projection matrix from data obtained during the standard C-arm calibration procedure. The method also includes offsetting the movable stage of the x-ray detector to a first position, generating a first set of transform offset parameters, offsetting the movable stage of the x-ray detector to a second different position, and generating a second set of transform offset parameters.

In a fifth aspect, a computer-readable medium having instructions executable on a computer stored thereon is described. The instructions include creating a virtual x-ray detector having a size greater than an actual x-ray detector, the actual x-ray detector being associated with a C-arm imaging system, wherein the virtual x-ray detector facilitates reducing truncation projection errors in volumes reconstructed by the C-arm imaging system.

The present invention is defined by the following claims. Nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The present invention will become more fully understood from the detailed description given herein and the accompanying drawings which are given by way of illustration only, and are not limitative of the present invention, and wherein:

FIG. 1 illustrates an exemplary C-arm x-ray imaging system;

FIG. 2 illustrates another exemplary C-arm x-ray imaging system;

FIG. 3 illustrates an exemplary imaging coordinate system;

FIG. 4 illustrates an exemplary pair of x-ray detectors having a movable stage;

FIG. 5 illustrates another exemplary x-ray detector;

FIG. 6 illustrates another exemplary pair of x-ray detectors;

FIG. 7 illustrates an exemplary detector translation stage;

FIG. 8 illustrates a flow chart of an exemplary method for reducing truncation projection errors;

FIG. 9 illustrates an exemplary data processing system;

FIG. 10 illustrates a flow chart of an exemplary calibration method; and

FIG. 11 illustrates an exemplary representation of calibration related data.

### DETAILED DESCRIPTION OF THE PREFERRED EMBODIMENTS

A C-arm x-ray imaging system acquires two dimensional x-ray projections and it may reconstruct associated three dimensional volumes internal to a patient. If the detector is too small to fully capture the patient's x-ray projections at the detector, reconstructed images suffer from artifacts. In that case, the imaging system may reconstruct enhanced images by creating an effective x-ray detector of greater size that may reduce truncation errors. The x-ray detector may include a movable stage and a detector mount. The movable stage may be movable within the x-ray detector mount. A first partial circular scan may be performed with the movable stage at a first position. Subsequently, the movable stage may be repositioned to a second position before performing a second partial circular scan. By performing two or more partial circular scans with the movable stage located at different positions, the effective size of the x-ray detector may be enlarged, because associated x-ray projections images taken at the same angular position can be combined to enlarge the efficient detector field of view. A second calibration procedure must be performed (in addition to the standard 3D geometry calibration) to take into account offset detector positions.

The C-arm imaging system may include an x-ray detector or a component thereof that may be laterally moved into different offset positions. For example, the x-ray detector or component thereof may be moved into oppositely offset positions when performing two successive partial circular scans along the same trajectory. For example, this is the case when acquiring x-ray projection data for digital subtraction angiography (DSA). The C-arm may move along the same scan trajectory during each of the two image acquisition runs, such as supported by current angiography C-arm systems facilitating DSA runs. DSA trajectories have been designed to take images at precisely the same positions to minimize subtraction artifacts or additional structural noise due to misaligned projections.

The C-arm imaging system may include an adjustable x-ray source collimator that moves in sync with the x-ray detector into its offset positions. The collimator may reduce radiation exposure to body regions that are no longer viewable under offset detector positions. The system may synthesize composite views by efficient interpolation and/or combination of the separate views taken with the x-ray detector, or component thereof, in offset positions. The imaging system may employ the known Feldkamp algorithm or other reconstruction algorithm to reconstruct a two or three dimensional volume based upon the composite views.

I. Conventional C-arm Imaging Systems

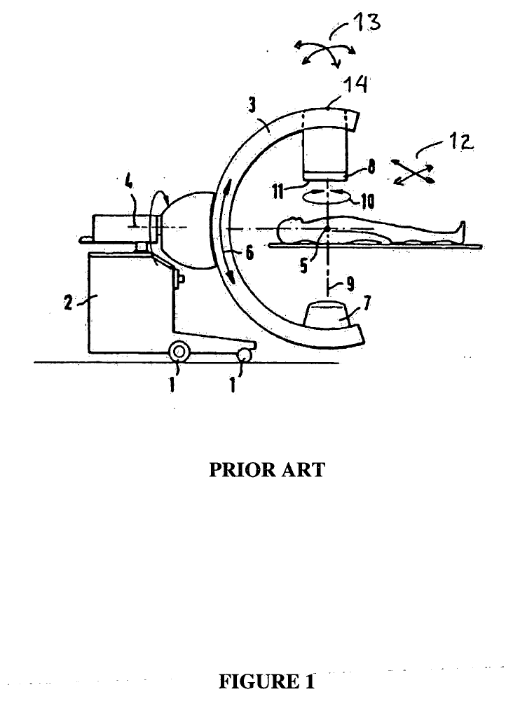

C-arm x-ray imaging systems are known in the art. C-arm imaging systems may be rotatable with respect to a patient about the x, y, and/or z-axes of a real world coordinate system. For instance, FIG. 1 is an exemplary C-arm imaging system as disclosed by U.S. Pat. No. 6,811,313, which is incorporated herein by reference in its entirety. The exemplary C-arm imaging system shown in FIG. 1 is composed of a base frame 2 movable on wheels 1 having a C-arm 3 rotatable around the axis 4 (such motion being referred to as angulation). The C-arm 3 may be turned around an axis 5 in the direction of the double arrow 6 (such motion being referred to as orbital rotation).

An x-ray source 7 and a detector 8, such as a rectangular flat detector, residing approximately 180 degrees opposite one another, are secured near each end of the C-arm 3. The detector may be coupled with the C-arm 3 by a mounting arrangement 14 so as to be either rotatable (circular double arrow 10) around the axis 9 proceeding to the x-ray source 7 (through the iso-center coinciding with the axis 5) and/or displaceable parallel to the detector surface 11, as well as perpendicular to the plane of the C-arm 3, as indicated by the double arrow 12.

The detector 8 may be displaced from its initial position shown in FIG. 1 along an arcuate path. The arcuate path preferably extends along the curvature of the C-arm 3 or intersects the C-arm 3 at a right angle, as indicated by the curved arrows 13. The C-arm imaging system may have additional, fewer, or alternate components for the same or different movements.

Alternatively, a floor mounted or ceiling mounted C-arm imaging system may be used to obtain a complete source trajectory. The ceiling mounted C-arm imaging system may be mounted to the ceiling via a L-arm or other structure. The L-arm may be rotatable about the connection between the ceiling and the L-arm such that the L-arm provides the C-arm with rotation about one or more axes with respect to the patient. The connection between the L-arm and the C-arm may provide the C-arm with rotation about another axis with respect to the patient, similar to the angulation illustrated by FIG. 1. Additionally, the C-arm may be rotatable around the patient via the orbital rotation of the C-arm through a sleeve. Alternate C-arm imaging systems may be used.

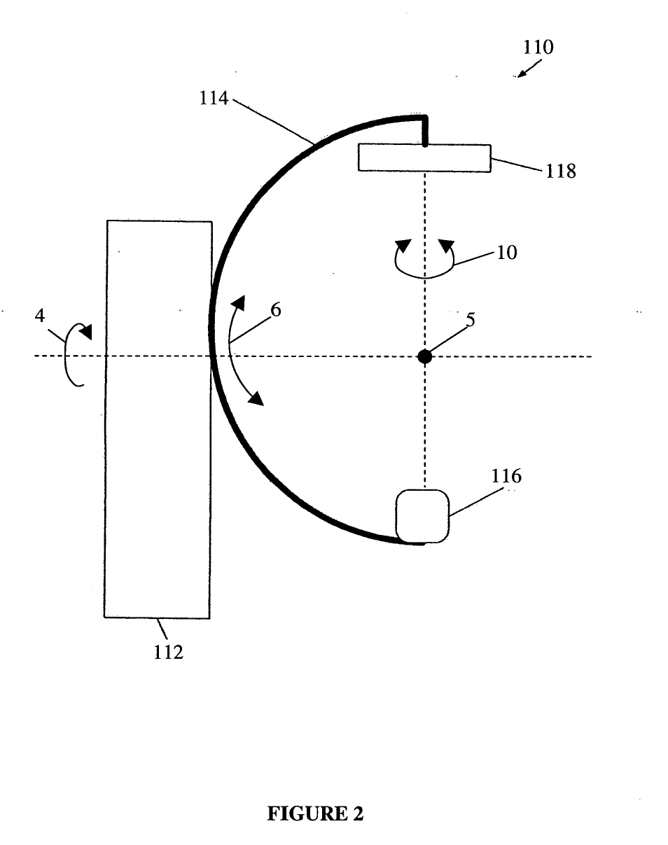

For example, FIG. 2 illustrates a C-arm x-ray imaging system 110, having a gantry 112 supporting a C-arm 114. The C-arm 114 has at one end an x-ray source 116 and a detector 118 at the other end. The C-arm 114 defines a plane. The C-arm 114 may swivel around an axis perpendicular to the plane during angulation. The C-arm 114 also may turn around a propeller axis (see 4 in FIG. 2) and around the perpendicular axis (10 in FIG. 2). The C-arm 114 also may move within a sleeve (see 6 in FIG. 2). During a partial circle scan, the C-arm 114 may angulate to generate views from multiple angles. The detector 118 may rotate around the axes defined by the detector 118 and the source 116.

II. Exemplary Detector Coordinate System

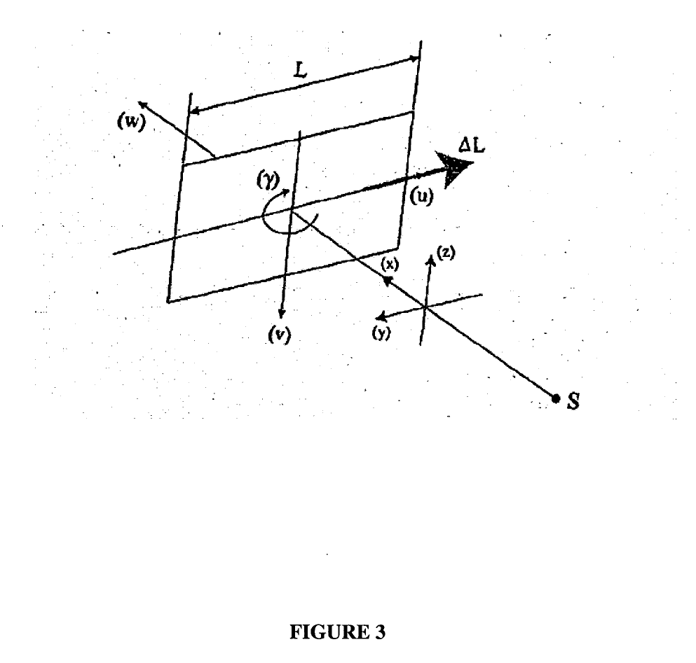

The C-arm imaging system may provide functionality to shift and rotate an x-ray detector. FIG. 3 illustrates an exemplary imaging geometry of such a system. A (u, v, w) detector coordinate system may rotate around the rotation axis (z-axis) of an (x, y, z) world coordinate system. The x-ray detector, or component thereof, may be rotated by y around the optical axis (w-axis). The coordinate systems are defined such that z-axis and w-axis both run along the optical axis. However, they may either be parallel or anti-parallel depending on what's more mathematically convenient. In addition, the x-ray detector, or component thereof, may be shifted laterally, i.e., in the u-direction shown, within a plane orthogonal to the optical axis. In the example shown, the x-ray detector may be shifted by ΔL. In one embodiment, L is a length associated with the x-ray detector or a component thereof, such as a movable stage.

Additionally, the rotation by y may facilitate arbitrary planar shifts within a plane orthogonal to the optical axis. For example, a shift opposite to the u-direction shown may be achieved by setting γ=π while performing a similar mechanical shift as before. Put differently, the mechanical shift may be unilateral if the x-ray detector is allowed to rotate.

In one embodiment, the field of view for two or three dimensional C-arm applications may be increased when two partial circular scans (such as DYNAVISION runs) are performed with an x-ray detector, or component thereof, shifted into oppositely offset positions. However, the offset detector positions may have to be reproducible. As a consequence, the x-ray detector may have to be fixed in a calibration position(s), such as by using a clamping mechanism.

To compute the effective detector width, L_{eff}, for two or three dimensional reconstruction, the detector shift in the positive u-direction is denoted herein by ΔL. Assuming a symmetric detector shift to the left and right, the effective detector width may be defined as follows:
L_{eff}=L+2·ΔL.
The diameter of the scan field of view (SFOV) after image reconstruction may be defined as:

$${D}_{SFOV} = \frac{SOD}{SID} {L}_{eff} .$$

The scan field of view comprises all pixels/voxels that may be viewed for at least approximately 180°. The term SOD is an abbreviation for source-origin distance (focal radius), and the term SID stands for source-detector (image) distance. Typical values for AX C-arm imaging systems may include 750 mm for SOD and 1150 mm (or larger) for SID. Using these typical values, the diverging beam geometry may reduce the detector width to approximately 65% at the center of rotation (iso-center). The x-ray detector shift, ΔL, may be employed to compensate for this effect. In one embodiment, for an x-ray detector having a length of approximately 40 cm, a shift of the x-ray detector by about 11 cm in either direction may enhance the accuracy of reconstructed volumes. Other sizes may be used.

To avoid a gap in the middle, the x-ray detector may be shifted by less than approximately ΔL=L/2. That is, the effective detector width may be at most twice the original detector width without compensating for noncontiguous data. Therefore, some overlap in the center detector region may be preferable in some situations.

The C-arm x-ray imaging system may facilitate keeping the object, i.e., the patient, at a stationary position, which may be necessary for accurate medical imaging. The C-arm imaging system may utilize only partial circular scans. As a result, a 360° gantry rotation is not required.

The imaging system may enlarge the artifact-free (no truncation artifacts caused by incompletely captured projections at the detector) reconstruction zone by shifting and tilting the x-ray detector. For example, shifting an approximately 40 cm x-ray detector by approximately 10 cm to either side may increase the effective x-ray detector field of view for reliable three dimensional reconstruction by approximately 50% or greater. With an approximately 40 cm x-ray detector and a standard C-arm projection geometry, a detector field of view at the iso-center may be obtained having a diameter of about 40 cm. The diameter may be limited to about 26 cm when the x-ray detector is not shifted. If a rotation of the x-ray detector by γ=π is possible, the x-ray detector may need only be shifted in one direction to reconstruct enhanced volumes.

For consistent image reconstruction based on extrapolated projections acquired with the imaging system, the image mass, as well as the center of mass, may be estimated. To accurately estimate the image mass and the center of mass, the complete object shadow may have to be recaptured in at least some of the x-ray projections taken. Using a shiftable detector, this can be achieved easily by taking multiple projections that are offset with respect to each other while the patient stays still. After acquisition, the offset projections are combined to obtain a larger detector field of view. Standard C-arm calibration techniques may be used to determine the projection geometry and/or projection matrices, even when the x-ray detector or component thereof is offset. Once the projection matrices are known, composite views may be synthesized. Composite views may combine corresponding oppositely offset views taken under the same or similar projection angles into a larger comprehensive projection. The effective width, L_{eff}, depends on how much the x-ray detector or component thereof was oppositely offset. In one embodiment, the x-ray detector or component thereof is oppositely offset by ΔL during calibration.

The C-arm imaging system may generate fluoroscopic stereo pairs by taking a center view and combining the center view with a projection taken under a laterally shifted position, either to the left or to the right. The x-ray source may remain in a fixed position, but the focal spot may have to be shifted. In addition to having a movable stage, the C-arm imaging system also may have a movable source.

The C-arm imaging system having a shiftable detector may enhance standard examinations as the need to change the C-arm viewing position may be alleviated. For instance, the x-ray detector may be adjusted when a catheter is about to leave the x-ray detector field of view essentially following it until it cannot be shifted any more. At that point the patient has to be moved. Additionally, shifting the x-ray detector does not necessarily mean that the previously acquired detector field of view is lost. As long as the C-arm view direction does not change, the new views and the previous views may be combined together to obtain a larger “effective” detector field of view.

III. Exemplary X-ray Detector Embodiments

Multiple exemplary x-ray detector embodiments for facilitating a lateral detector shift and rotation are presented herein. Other x-ray detector embodiments may be used having additional, fewer, or alternate components.

The imaging system may include one or more powered actuators (motors) to shift laterally and/or to rotate the x-ray detector or component thereof. Standard stepping motors may be used. For example, the lateral shift may be implemented using gears and a toothed rail (commonly referred to as a gear rack).

The imaging system may include a clamping mechanism that fixes the x-ray detector or component thereof into its offset position(s). The clamping mechanism may operate to repeatedly fix the x-ray detector or component thereof into the same position such that the C-arm projection geometry may be reproducible. Alternatively, the imaging system may include a sensor that precisely measures by how much to offset and/or rotate the x-ray detector or component thereof for reproducible results. Alternate manners of ensuring reproducible results may be used.

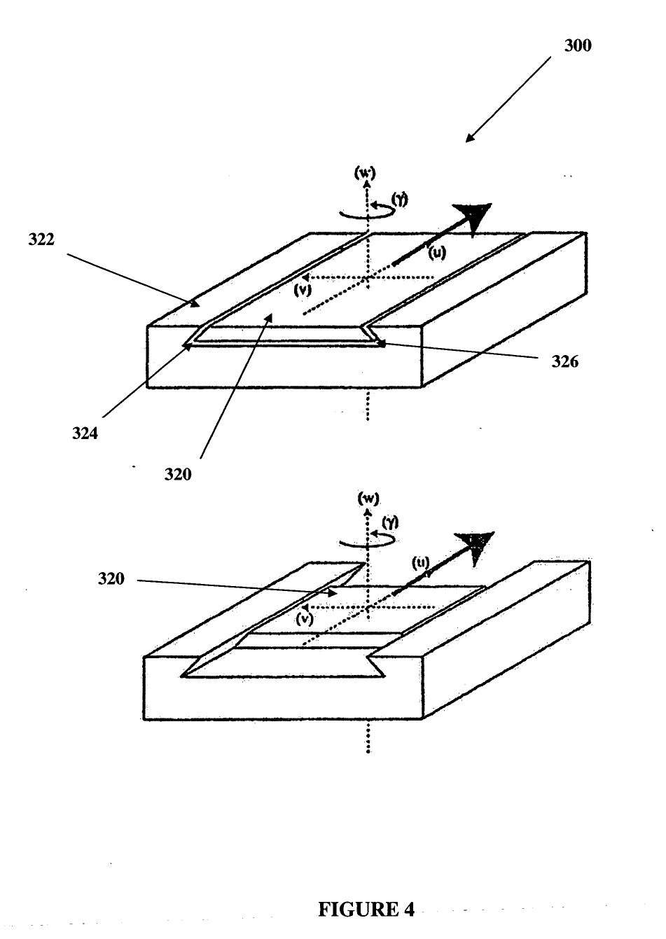

FIG. 4 illustrates an exemplary pair of x-ray detectors 300. The x-ray detector 300 may include having a movable stage 320, a detector mount 322, a first slide 324, and a second slide 326. The x-ray detector 300 may include additional, fewer, or alternate components.

The example in FIG. 4 illustrates that the x-ray detector 300 may be a free bilateral offset detector. The detector mount 322 may include the first and second slides 324, 326 to hold and translate the movable stage 320. Fewer or more slides may be used. The first and second slides 324, 326 may be configured as dove tails or other structures well known to the mechanical arts.

The movable stage 320 may be capable of detecting x-rays emitted from an x-ray source. The movable stage 320 may be manufactured from conventional detector materials, including but not limited to silicon, gallium arsenide, cadmium telluride, and cadmium zinc telluride.

More specifically, the upper example of FIG. 4 shows a movable stage 320 that has approximately the same width as an interior surface of the detector mount 322. This setup may guide the movable stage 320 of the x-ray detector 300 along its entire lateral offset. In other words, precise lateral movement of the movable stage 320 may be possible up to ΔL=L/2.

The lower example of FIG. 4 shows an embodiment having a smaller movable stage 320. In some situations, the embodiment having a smaller movable stage 320 may simplify construction of the x-ray detector, such as in the case of the x-ray detector including a detector collision sensor.

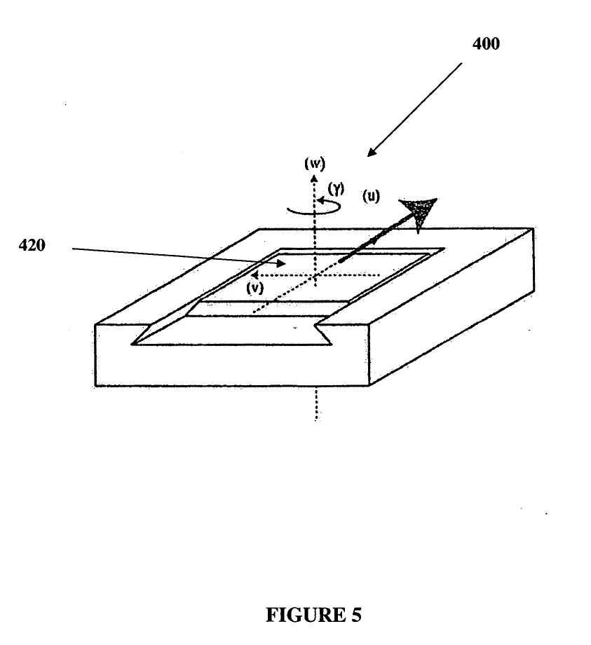

FIG. 5 illustrates another exemplary x-ray detector 400. The x-ray detector 400 shown is a free unilateral offset detector. In the example of FIG. 5, if the x-ray detector 400 is capable of being rotated by γ=π around the optical axis (w-axis), then a bilateral offset is effectively provided. In one embodiment, the unilateral offset is sufficient to shift the movable stage 420 of the x-ray detector 400 up to approximately ΔL=L/2. Additionally, a detector configuration with a free (bilateral or unilateral) offset facilitates detector exchange. For instance, the detector mounts as shown in FIGS. 4 and 5 may support a C-arm system in which the system may readily switch among multiple detectors.

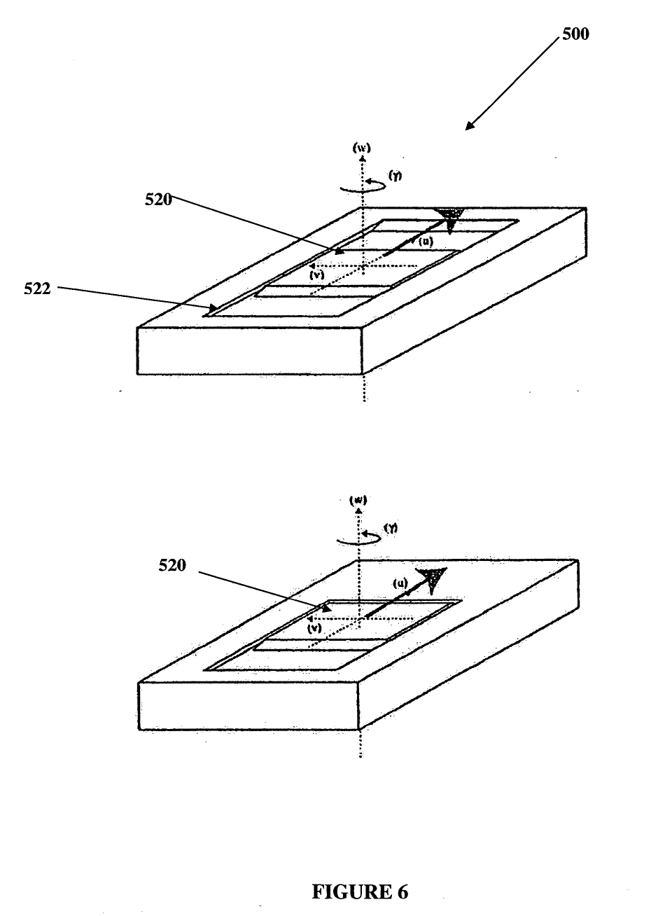

FIG. 6 illustrates another pair of exemplary x-ray detectors 500. The upper example of FIG. 6 shows an x-ray detector 500 that is a restricted bilateral x-ray detector. The lower example of FIG. 6 shows an x-ray detector 500 that is a restricted unilateral offset x-ray detector. The movable stage 520 may be held in place by the detector mount 522. The movable stage 520 may move either bilaterally or unilaterally. However, the movement of the movable stage 520 is restricted by one or more end plates, posts or other structures on the detector mount 522.

If the imaging system is capable of rotating the x-ray detector 500 around the w-axis by π, unilateral motion may place the x-ray detector 500 into oppositely offset positions. Due to the end plates of the detector mount 522, the offset movement of the movable stage 520 is limited as compared to the offset possible with the configurations shown in FIGS. 4 and 5. A maximum detector offset may be ΔL=L/4, in one example, which may provide an effective width of the movable stage capable of precise lateral detector alignment. Other offset limits may be provided.

The embodiments in FIGS. 4 to 6 illustrate translation stages having one-sided dovetails. In some situations, the dovetails may present difficulties for a high-precision imaging system because of relatively high friction and stiction (breakaway friction). Accordingly, an x-ray detector with one or more crossed-roller bearings may facilitate an enhanced solution that may alleviate problems associated with dovetail joints.

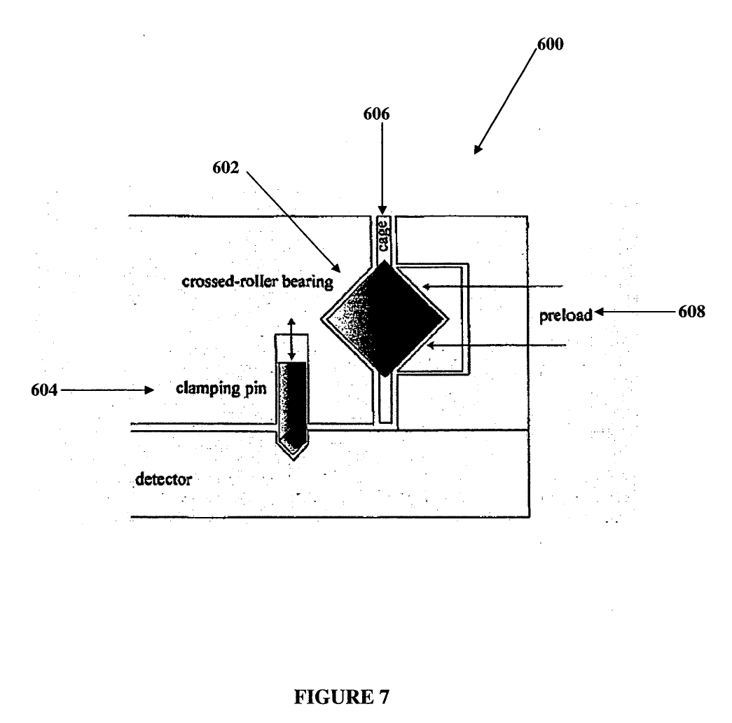

FIG. 7 illustrates an exemplary detector translation stage 600. The detector translation stage 600 shown includes a crossed-roller bearing 602, a clamping pin 604, a cage 606, and a preload 608. The detector translation stage 600 may include additional, fewer, or alternative components.

The crossed-roller-bearings 602 may be held apart from one another by a cage 606 to prevent adjacent roller-bearings 602 from touching. The cross-roller bearings 602 may have larger load-bearing surfaces than typical ball bearings and may tolerate a higher preload, carry greater weight, and satisfy very precise specifications.

The clamping mechanism 604 may ensure that the detector is reproducibly fixed at a calibration position. For example, movement of the clamping pin 604 may prevent and/or permit lateral movement of the movable stage. The clamping pin 604 may hold the movable stage in a specific position that is identifiable by the imaging system such that reproducible results may be achieved.

Alternate manners of achieving reproducible results may be used. For example, the imaging system may include a sensor or other component that facilitates the precise positioning and/or tracking of the x-ray detector or component thereof such that a clamping device is not necessary. In such a situation, the x-ray detector or component thereof may be repositioned while the C-arm moves along an image acquisition trajectory. Additionally, for two dimensional fluoroscopic projections, the x-ray detector or component thereof may be freely moved (translated and rotated) in a plane orthogonal to the optical axis. This may provide an interventional radiologist with more flexibility when re-positioning the x-ray detector or component thereof.

IV. Exemplary Methods and System

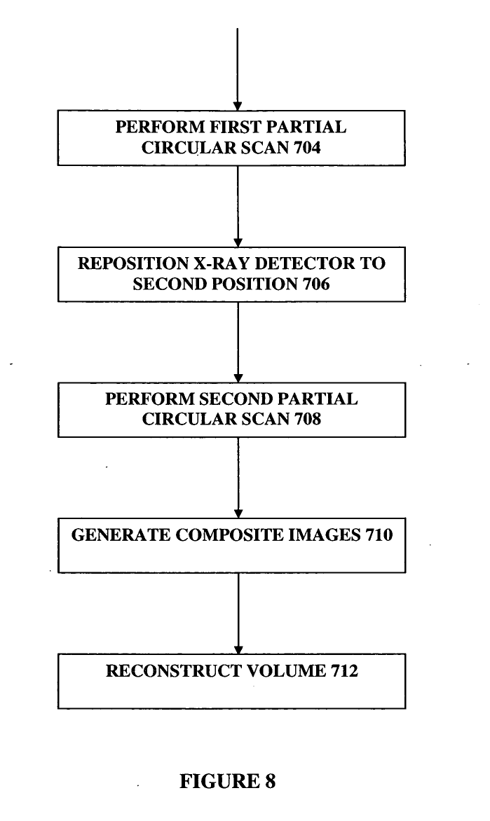

FIG. 8 illustrates a flow chart of an exemplary method for reducing truncation projection errors 700. The method 700 may include positioning the x-ray detector or a component thereof to a first position 702, performing a first partial circular scan 704, repositioning the x-ray detector or a component thereof to a second laterally offset position 706, performing a second partial circular scan 708, generating composite images 710, and reconstructing a volume 712. The method may include additional, fewer, or alternate actions.

The method 700 may include positioning the x-ray detector or a movable component thereof to a first position 702. In one embodiment, the movable stage is positioned in a first position by moving it by a lateral offset ΔL from the w-axis of FIGS. 4 to 6 (center of the x-ray detector). Alternatively, the first position may be the center of the x-ray detector. Other first positions may be used.

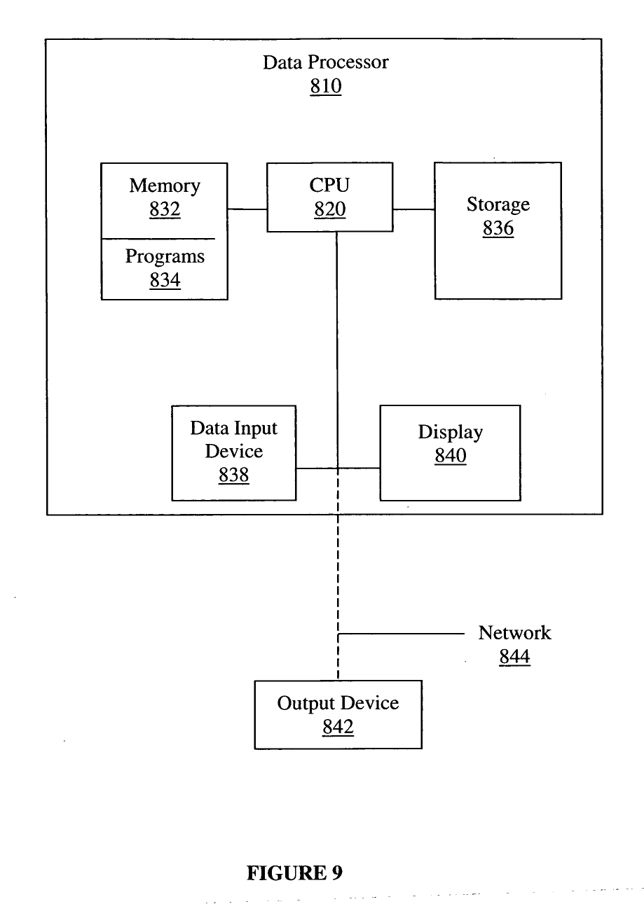

The method for reducing truncation projection errors 700 may employ a data processing system. FIG. 9 illustrates an exemplary data processor 810 configured or adapted to be part of the C-arm imaging system. The data processor 810 may include a central processing unit (CPU) 820, a memory 832, a storage device 836, a data input device 838, and a display 840. The processor 810 also may have an external output device 842, which may be a display, a monitor, a printer or a communications port. The processor may have additional, fewer, or alternate components.

The processor 810 may be a personal computer, work station, pictorial archival communication system (PACS) station, C-arm imaging system, x-ray system, or other medical imaging system. The processor 810 may be interconnected to a network 844, such as an intranet, the Internet, or an intranet connected to the Internet. The processor 810 is provided for descriptive purposes and is not intended to limit the scope of the present system.

A program 834 may reside on the memory 832 and include one or more sequences of executable code or coded instructions that are executed by the CPU 820. The program 834 may be loaded into the memory 832 from the storage device 836. The CPU 820 may execute one or more sequences of instructions of the program 834 to process data. Data and/or instructions may be input to the processor 810 with the data input device 838 and/or received from the network 844. The program 834 may interface the data input device 838 and/or the network 844 for the input of data. Data processed by the processor 810 may be provided as an output to the display 840, the external output device 842, the network 844, and/or stored in a database. The program 834 and other data may be stored on or read from machine-readable medium, including RAM, cache, or secondary storage devices such as hard disks, floppy disks, CD-ROMS, and DVDs; electromagnetic signals; or alternate forms of machine readable medium, either currently known or later developed.

The processor 810 may direct the imaging system to perform multiple partial circular scans. The processor 810 may run a software application or program 834 that performs a number of operations related to the imaging system. The processor 810 may access data stored on or read from machine-readable medium, including RAM, cache, or secondary storage devices such as hard disks, floppy disks, CD-ROMS, and DVDs; electromagnetic signals; or alternate forms of machine readable medium, either currently known or later developed.

The processor 810 may move the imaging system to a first position with respect to a patient, such as directing the movement of the x-ray detector or component thereof to a first position. The CPU 820 may calculate the current position of movable components of the imaging system within a real world coordinate system. For instance, the CPU 820 may calculate the position of the x-ray detector or the movable stage within a real world coordinate system with respect to the patient. As a result, the processor 810 may move the x-ray detector, the movable stage, or other imaging system component to a first position.

After the x-ray detector or a component thereof has been moved to a first position 702, the method may include performing a first scan 704. The processor 810 may direct the imaging system to perform the first scan, such as a first partial circular scan. The projections of the first source trajectory acquired may be received by the data input device 838, the network 844, or other input device and/or stored in the memory 832, the storage 836, or other storage unit. In one embodiment, the first partial circular scan 704 is performed with the movable stage in the first position.

The method 700 may include repositioning the x-ray detector or component thereof 706. The processor 810 may reposition the x-ray detector or component thereof with respect to the patient. The CPU 820 may monitor the relative repositioning of the x-ray detector, or a component thereof, such as the movable stage. By monitoring the movement of the x-ray detector or component thereof with respect to the patient, the processor 810 may correctly reposition the x-ray detector, or component thereof, by a predetermined amount, such as approximately a length L of the x-ray detector or component thereof.

In one embodiment, the movable stage is repositioned. In another embodiment, the movable stage may be shifted to a second position that is laterally offset a negative ΔL, a negative ΔL/2, or other distance from the w-axis. For instance, the second position may be laterally offset by a length of the x-ray detector from the w-axis. Other second positions may be used.

After repositioning the x-ray detector or a component thereof, the method 700 may include performing a second scan 708. The processor 810 may direct the imaging system to perform the second scan, such as a partial circular scan. The projections of the second source trajectory acquired may be received by the data input device 838, the network 844, other input device and/or stored in the memory 832, the storage 836, or other storage device.

The method 700 may include generating composite images 710. The composite view may be generated by integrating data and images obtained from both the first and second partial circular scans. The data processor 810 may create a composite view by interpolating data associated with the first and second partial circular scans and synthesizing the data. The result of the interpolation of the data acquired via partial circular scans with the center stage of the actual x-ray detector laterally offset during either or both scans may be the creation of an effective or virtual x-ray detector of greater size or length than the actual x-ray detector.

The method may further include employing a reconstruction algorithm to reconstruct a two or three dimensional volume 712. For instance, the processor 810 may use the composite x-ray projections and reconstruct the volume within the patient using a reconstruction algorithm stored in the memory 832, the storage 836, or other storage device or accessible over the network 836. The reconstructed volume may be displayed on the display 840, the output device 842, or other output device and/or stored in the memory 836, the storage 836, or other storage device.

The method identified above to reduce truncation projection errors may create two or more (projection) data sets. The data sets may each be associated with a partial circular scan that has a defined detector displacement from another scan having the same source cone of x-rays. The data sets may be operated on by the data processor 810 to create views associated with an effective or virtual detector, or component thereof, having a greater size and/or length than the actual x-ray detector, or component thereof, respectively, that may eliminate the truncation projections.

V. Calibration

To enhance the effectiveness of the above method, the projection geometry may be determined by a calibration procedure. To this end, a calibration phantom may be placed at the C-arm iso-center, a location where the calibration phantom is completely visible for every view.

Depending on the accuracy and the amount of the lateral detector shift, the standard C-arm geometry calibration procedure may be still be sufficient for accurate results in particular when composite views are generated by simple stitching of associated offset projections. For instance, if the detector offset is small, for example ΔL=10 cm where the movable stage is about 40 cm, the standard calibration procedure may be sufficient. For an intermediate detector shift, the standard calibration procedure may be performed twice to achieve reasonable results. Specifically, the standard calibration procedure may be performed once for each position of the movable stage or other movable component of the x-ray detector. However, if the detector offset is relatively large, each view may no longer fully capture the projection of the calibration phantom. Then an alternative is needed outlined below.

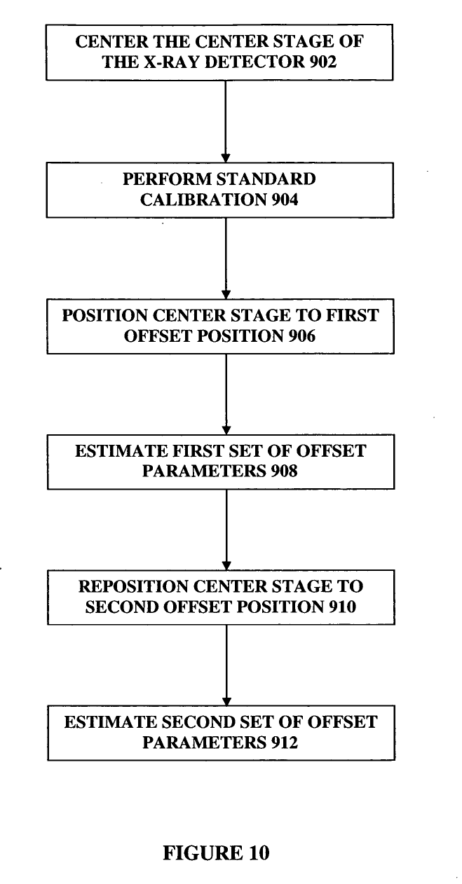

FIG. 10 illustrates a flow chart of an exemplary calibration method 900. The calibration method 900 may include centering the x-ray detector or a movable component thereof, such as the movable stage, 902 and performing a standard calibration with the x-ray detector or movable component thereof centered 904. The standard calibration procedure involves a partial circle scan generating a set of projection matrices. There is one projection matrix for each view describing the underlying projection geometry. The method also may include positioning the x-ray detector or movable component thereof to a first offset position 906, estimating a first set of offset parameters 908, repositioning the x-ray detector or movable component thereof to a second offset position 910, and estimating a second set of offset parameters 912. The offset parameters are then used to generate composite X-ray views from associated offset views using warping techniques. The composite views and their associated projection matrices are finally fed into the reconstruction algorithm for 3D reconstruction. The method may include additional, fewer, or alternate actions.

The calibration method detailed above may generate a set of projection matrices associated with the x-ray detector or component thereof in a centered position, as well as first and second offset parameters associated with the first and second offset positions, respectively. The calibration method also may include generating a set of final projection matrices for each actual partial circular scan.

The final projection matrices may be generated off line. Alternatively, the centered projection matrices may be stored with the offset parameters and the appropriate final projection matrices may be determined “on-line” and/or in real time during the scan. Real time determination of final projection matrices may rely upon a number of different offset parameters to adjust the centered projection matrices. For example, different organs may require different detector offsets to avoid truncation errors due to the size of the organs. Thus, for a particular organ, a specific offset may be stored in a memory and available for use. More specifically, different system settings, e.g., “organ programs”, may be used to perform DYNAVISION image acquisition scans or other scans involving laterally offset detector positions. Otherwise, the image reconstruction algorithm may not be able to determine what detector offset position (and, hence, projection matrix) the input images are associated with.

In one embodiment, the above described set of projection matrices and offset (transform) parameters are related as described below. The projection geometry of the nth view is described by the projection matrix Pₙ. There are N viewing positions (projection angles). A projection identified as taken under Pₙ indicates that the projection is taken with the source in its n^{th} position.

A very precise mechanical shift mechanism may restrict the shift to be approximately planar and a clamp may hold the x-ray detector or movable component thereof in place during C-arm rotation. The shift parameters may be estimated under one particular C-arm viewing angle along the image acquisition trajectory, e.g., the posterior-anterior position. If the x-ray detector or movable component thereof cannot be rigidly held in its offset positions, the shift/transform parameters for all N viewing positions may have to be determined.

Assuming a stable clamping mechanism, the default projection matrix for the chosen view geometry is identified herein as P₀. The associated projection matrix with the x-ray detector or moveable component thereof at its i^{th} shift position (to the right) is denoted as P₀⁽ⁱ⁾. The projection matrix may be computed from P₀⁽ⁱ⁾ by taking P₀⁽ⁱ⁾=Tᵢ·Pₙ with a suitably chosen transform matrix Tᵢ. One possible choice to Tᵢ is a Eucliclean similarity transform (Eucliclean warp) defined as:

$$Ti = [ \begin{matrix}{s}_{i} cos ( {α}_{i} ) & {s}_{i} sin ( {α}_{i} ) & {t}_{u}^{( i )} \\ - {s}_{i} sin ( {α}_{1} ) & {s}_{i} cos ( {α}_{1} ) & {t}_{v}^{( i )} \\ 0 & 0 & 1\end{matrix} ]$$

The above transform involves four offset parameters for scale, sᵢ, rotation, αᵢ, horizontal translation, tᵤ⁽ⁱ⁾, and vertical translation, tᵥ⁽ⁱ⁾. The transform matrix associated with Tᵢ, but with the detector shifted into its oppositely lateral position (to the left), is called T₋ᵢ.

To estimate the four offset parameters, at least two points that remain visible when projections are taken under P₀ and P₀⁽ⁱ⁾, respectively, may be needed. Once the shift parameters are estimated, and assuming that a particular shift remains stable during the image acquisition run, projection matrices are obtained for all other N-1 view directions according to Pₙ⁽ⁱ⁾=Tᵢ·Pₙ.

A simple calibration phantom facilitating the estimate of the shift parameters would be a Lucite plate of embedded beads of two different sizes. The beads may be used to establish binary code words. The size of the beads may be chosen such that the larger beads are significantly bigger than the smaller beads regardless of the magnification due to the divergent-beam projection geometry. Once beads of two significantly different sizes are provided, they can be used to express binary code words (e.g., a small bead for “0”, and a large bead for “1”).

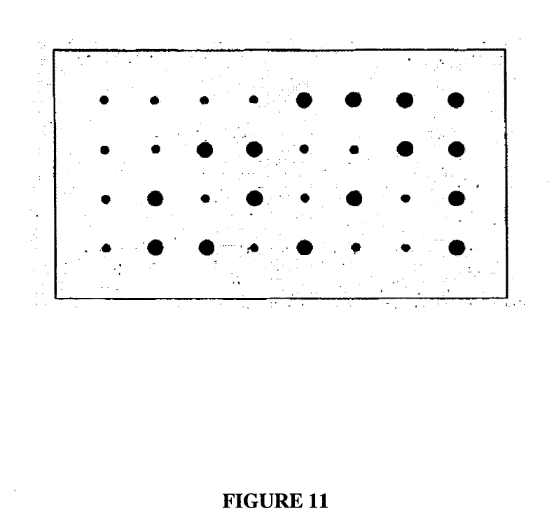

FIG. 11 illustrates an exemplary image of calibration related data. A linear code with 3 bits may be used and one parity bit having a Hamming distance of two may be used. In this example, neighboring columns may always have two beads next to each other that have different sizes. In addition, each row may have a unique pattern. Such a bead distribution may simplify picking (at least) four beads (two in each pair of adjacent columns) that are both seen under P₀ and P₀⁽ⁱ⁾, respectively. For a more reliable estimate of the transform offset parameters, more than two beads may be used. Other “code” designs of the calibration plate may be used.

After two partial circular scans are performed, the two sets of projections may be merged to create a composite projection. To combine oppositely offset projections taken under Pₙ⁽ⁱ⁾=Tᵢ·Pₙ and Pₙ^{(-i)=T}₋ᵢ·Pₙ, a new extended pixel grid that is associated with Pₙ may be defined.

To compute a composite projection, the new grid positions are mapped onto the previous grid positions. Previous pixel grid positions on the detector shifted to the left may be found by pre-multiplying the extended grid coordinates with T₋ᵢ⁻¹. Previous pixel grid positions on the detector shifted to the right may be found by pre-multiplying the extended grid coordinates with Tᵢ⁻¹. If the oppositely shifted detectors have a central region in common, associated gray levels in both projections may be determined and averaged. As a result, noise may be reduced, i.e., the method and system may make use of the fact that the overlapping detector region was irradiated twice. Clearly, from an x-ray dose point of view, keeping the overlap region small is preferred.

Due to the discrete nature of raster images, each pixel position in the extended grid may not map directly to another (discrete) pixel position on the offset grid. Accordingly, the resulting gray level in the extended pixel grid may be determined by bilinear interpolation between the neighboring samples of the previous pixel grids. After the composite view is created, a standard two or three dimensional reconstruction technique may be applied generate an-image of the volume being scanned.

While the invention has been described above by reference to various embodiments, it should be understood that many changes and modifications can be made without departing from the scope of the invention. The description and illustrations are by way of example only. Many more embodiments and implementations are possible within the scope of this invention and will be apparent to those of ordinary skill in the art. The various embodiments are not limited to the described environments and have a wide variety of applications.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except in light as necessitated by the accompanying claims and their equivalents.

What is claimed is:

1. An x-ray imaging system comprising:
an x-ray source mounted to one end of a C-arm; and
an x-ray detector mounted to an opposite end of the C-arm, the x-ray detector comprising a detector mount and a movable stage, wherein the movable stage is operable to move within the detector mount.

2. The system of claim 1, wherein the detector mount comprises a pair of slides, the movable stage being operable to translate along the slides.

3. The system of claim 2, wherein the movable stage is operable to move within the detector by approximately a length of the movable stage.

4. The system of claim 1, comprising one or more crossed roller bearings and clamping pins.

5. The system of claim 1, wherein the x-ray detector is mounted to the C-arm such that the x-ray detector may rotate around an axis defined by the x-ray source and the x-ray detector.

6. An x-ray detector of an imaging system comprising:
a detector mount operable to be coupled with a C-arm;
a movable stage coupled to the detector mount, the movable stage being operable to translate along the detector mount.

7. The x-ray detector of claim 6, wherein the detector mount having a first and a second slide, the first and second slides are approximately parallel to each other, and at least one of the first and second slides has a crossed roller bearing.

8. The x-ray detector of claim 6, comprising one or more clamping pins.

9. A method of imaging employing a C-arm x-ray imaging system, the method comprising:
positioning a movable stage of an x-ray detector at a first position;
performing a first partial circular scan to acquire a first set of projection data;
repositioning the movable stage of the x-ray detector to a second position laterally offset from the first position; and
performing a second partial circular scan to acquire a second set of projection data.

10. The method of claim 9, comprising:
generating composite projection data from the first and second sets of projection data; and
reconstructing a volume from the composite projection data.

11. The method of claim 10 wherein the volume is reconstructed using a Feldkamp algorithm or some other exact or approximate 3D reconstruction algorithm.

12. The method of claim 9, wherein a difference between the first position and the second position is up to a length of the movable stage.

13. The method of claim 9, comprising generating a first and second set of projection matrices from the first and second sets of projection data acquired during C-arm geometry calibration.

14. The method of claim 13, comprising calibrating the C-arm x-ray imaging system using the first set and second set of projection matrices such that composite views can be reconstructed.

15. A method of calibrating a C-arm x-ray imaging system, the method comprising:
centering a movable stage of an x-ray detector;
performing a standard C-arm geometry calibration procedure;
generating a set of projection matrices from data obtained during the standard C-arm geometry calibration procedure;
offsetting the movable stage of the x-ray detector to a first position;
generating a first set of transform offset parameters;
offsetting the movable stage of the x-ray detector to a second different position; and
generating a second set of transform offset parameters.

16. The method of claim 15, comprising generating composite views associated with a set of centered projection matrices by warping associated offset views. The warping is based on the transform offset parameters.

17. The method of claim 16, comprising calibrating the C-arm x-ray imaging system by adjusting the set of centered projection matrices using the first and second sets of transform offset parameters.

18. The method of claim 15, comprising:
generating a first set of projection matrices associated with the first set of transform offset parameters; and
generating a second set of projection matrices associated with the second set of transform offset parameters.

19. The method of claim 15, wherein the distance from the first position to the second position is up to the length of the movable stage.

20. A computer-readable medium having instructions executable on a computer stored thereon, the instructions comprising:
creating a virtual x-ray detector having a size greater than an actual x-ray detector, the actual x-ray detector being associated with a C-arm imaging system, wherein the virtual x-ray detector facilitates the reduction of truncation projection errors in volumes reconstructed by the C-arm imaging system.

21. The computer-readable medium of claim 20, the instructions comprising:
obtaining first data set associated with a first partial circular scan performing by a C-arm imaging system; and
obtaining second data set associated with a second partial circular scan performed by the C-arm imaging system.

22. The computer-readable medium of claim 21, wherein creating the virtual detector comprises integrating the first and second data sets.

23. The computer-readable medium of claim 22, the instructions comprising repositioning a component of the actual detector after the first partial circular scan and before the second partial circular scan.

24. The computer-readable medium of claim 22, the instructions comprising calibrating the C-arm imaging system by generating first and second projection matrices associated with first and second transform parameters, respectively.
